(19) United States
(12) Patent Application Publication
(10) Pub. No.: US 2017/0177676 A1
(43) Pub. Date: Jun. 22, 2017

(54) DYNAMIC ANALYSIS OF ENTITIES

(71) Applicant: SAP SE, Walldorf (DE)

(72) Inventors: Alaap Sivaram, Bangalore (IN); Prasad Ghodke, Bangalore (IN); Sudarshan Pavanje, Bangalore (IN); Prasanna Bhat Mavinakuli, Bangalore (IN)

(21) Appl. No.: 14/978,057

(22) Filed: Dec. 22, 2015

(51) Int. Cl. G06F 17/30

(52) U.S. Cl. CPC G06F 17/30554; G06F 17/3053

(57) ABSTRACT

In dynamic analysis of entities, a dataset including a set of entities and a corresponding set of parameters with values are received in an analytics application. An input for shortlisting an entity for a first position is received. Weights are assigned to the set of parameters based on a first set of criteria iteratively. Weighted values based on the weights and the values for the set of parameters are computed. Weighted average corresponding to the set of entities are computed. The set of entities in descending order of the weighted average are sorted. A first entity from the sorted set of entities in a user interface as a shortlisted entity for the first position is rendered.

### FIELD

Embodiments of the invention generally relate to data processing, and more particularly to a system to perform dynamic analysis of entities.

### BACKGROUND

In the process of selecting players for various sports such as football, basketball, etc., player scouts or physical scouts evaluate the players for selection. Typically, the physical scouts attend matches to observe players and decide on selection of players. The decision is generally made based on observation, instinct and suggestion of the physical scouts rather than on detailed analysis of data. Further, the physical scouts tend to decide a player based on few matches without considering all the matches played by the player. It is challenging to select players based on observation and instinct.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1A and FIG. 1B in combination are block diagrams illustrating user interfaces for dynamic analysis of entities, according to one embodiment.

FIG. 2 is a flow diagram illustrating analysis of scouting for goalkeepers using exemplary data, according to one embodiment.

FIG. 3 illustrates dynamic analysis of scouting for goalkeepers using exemplary data, according to one embodiment.

FIG. 4 illustrates dynamic analysis of scouting for goalkeepers using exemplary data, according to one embodiment.

FIG. 5 illustrates dynamic analysis of selection of goalkeepers using exemplary data, according to one embodiment.

FIG. 6 is a flow diagram illustrating analysis of scouting for defenders, according to one embodiment.

FIG. 7A and FIG. 7B in combination illustrates dynamic analysis of players in an opponent team using exemplary data, according to one embodiment.

FIG. 8 illustrates dynamic assignment of traits to players in a team using exemplary data, according to one embodiment.

FIG. 9 illustrates dynamic assignment of traits to players in a team using exemplary data, according to one embodiment.

FIG. 10 illustrates dynamic determination of man-to-man marking of players in set-pieces, according to one embodiment.

FIG. 11A and FIG. 11B in combination illustrates dynamic determination of man-to-man marking of players in set-pieces using exemplary data, according to one embodiment.

FIG. 12 is a flow diagram illustrating a process of dynamic analysis of entities, according to one embodiment.

FIG. 13 is a block diagram illustrating an exemplary computer system, according to one embodiment.

### DETAILED DESCRIPTION

Embodiments of techniques of a system to perform dynamic analysis of entities are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Physical scouts may rate various players on various parameters based on the performance of the players during various matches. Parameters are determined based on the sport selected. For example, in soccer for goalkeeper position, various parameters such as positional sense, anticipation, ball handling, jumping, acceleration, etc., are considered. The physical scouts provide scores to the players based on the individual parameters. Scores may also be automatically populated corresponding to the players using various algorithms, applications, etc. Individual parameters are based on position of the players in the sport. Individual players with scores for individual parameters may be used as raw data or dataset for analysis. Clustering algorithm or user-defined algorithm may be used to cluster players for individual positions based on a dataset including a specific set of parameters. It should be appreciated that the user-defined algorithm are not limited to the examples explained below, various other relevant user-defined algorithms may be used. The user-defined algorithms are equally applicable for various sports such as football, hockey, basketball, etc.

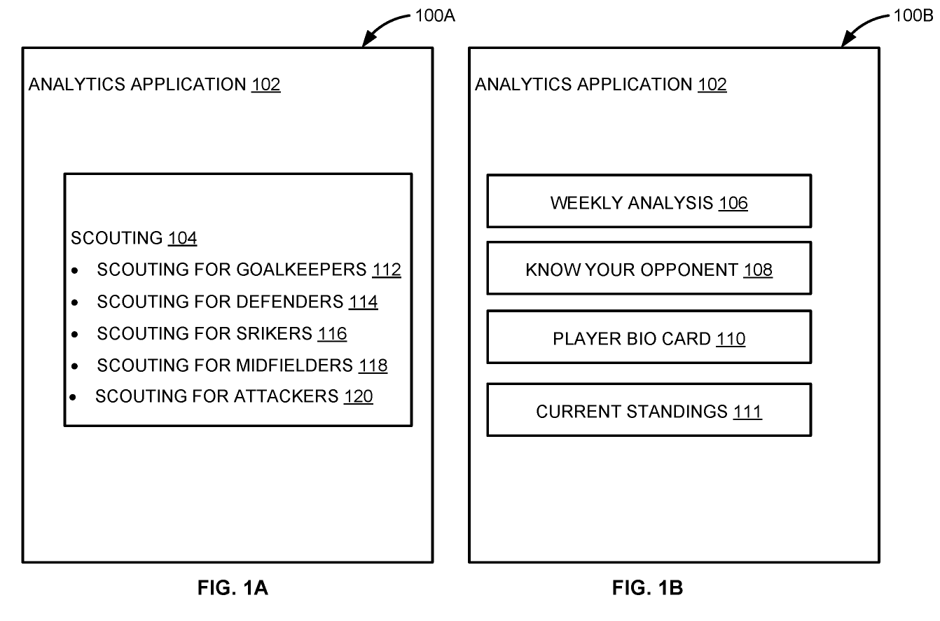

FIG. 1A and FIG. 1B in combination are block diagrams illustrating user interfaces 100A and 100B for dynamic analysis of entities, according to one embodiment. The user interfaces 100A and 100B as shown contains analytics application 102 with various features offering various functionalities for dynamic analysis of entities such as players in a sport. Features, parameters and functionalities indicated below are merely illustrative examples, however, various other additional features and additional functionalities may be provided by the analytics application 102. Various features shown in the user interface 100A are scouting 104, and in the user interface 100B are weekly analysis 106, know your opponent 108, player bio card 110 and current standings 111. Data collected by physical scouts corresponding to individual players are referred to as raw data or dataset for analysis. Based on the dataset available for individual players, analytics application 102 may be executed to perform features such as scouting for goalkeepers 112, scouting for defenders 114, scouting for strikers 116, scouting for midfielders 118 and scouting for attackers 120. When an individual feature is selected, a user-defined algorithm corresponding to the selected feature is executed by the analytics application 102, and the resulting players are rendered in the user interface 100A. For example, when the feature scouting for goalkeepers 112 is selected, an algorithm corresponding to the feature scouting for goalkeepers 112 is executed, and players are rendered as a result of the analysis in the user interface 100A.

Similarly, when the other individual features such as scouting for defenders 114, scouting for strikers 116, etc., are selected, a user-defined algorithm corresponding to the selected feature is executed and players are rendered based on the analyzed data. When the feature ‘weekly analysis’ 106, is selected, a user-defined algorithm is executed to analyze the performance of players in an opponent team, and a team of current players is suggested to counter opponent players in the opponent team. When the feature ‘know your opponents’ 108 is selected, details of an opponent team and analysis of opponent players in the opponent team are rendered. When the feature ‘player bio card’ 110 is selected, details of individual players in a database are rendered with various details such as name, age, nationality, goals, traits, etc. When the feature current standings 111 is selected, various teams are listed with their points and current position in a league.

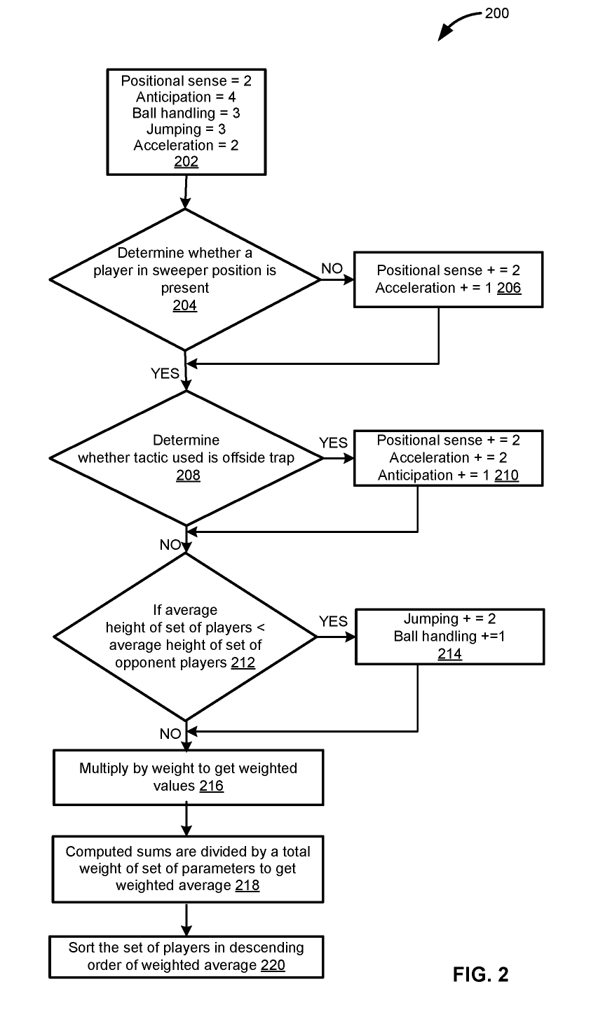

FIG. 2 is a flow diagram illustrating analysis of scouting for goalkeepers using exemplary data, according to one embodiment. Consider a set of players and a set of parameters such as positional sense, anticipation, ball handling, jumping and acceleration associated with the set of players. At 202, weights are assigned to a set of parameters associated with a position goalkeeper. For example, weight ‘2’ is assigned to the parameter positional sense, weight ‘4’ is assigned to the parameter anticipation, weight ‘3’ is assigned to the parameter ball handling. Similarly, weight ‘3’ is assigned to the parameter jumping, and weight ‘2’ is assigned to the parameter acceleration. At 204, it is determined whether a player in sweeper position is present. Upon determining that the player in sweeper position is not present, at 206, the parameter positional sense is incremented by ‘2’ and the parameter acceleration is incremented by ‘1’.

At 208, it is determined whether a parameter tactic used by the players is offside trap. Upon determining that the parameter tactic used is offside trap, at 210, the parameter positional sense is incremented by ‘2’, the parameter acceleration is incremented by ‘2’ and the parameter anticipation is incremented by ‘1’. At 212, it is determined whether an average height of the set of players is less than an average height of a set of opponent players. Upon determining that the average height of the set of players is less than the average height of set of opponent players, at 214, the parameter jumping is incremented by ‘2’ and the parameter ball handling is incremented by ‘1’. During scouting, criteria indicated in 212 may not be applicable. At 216, values corresponding to the set of parameters are multiplied by the weights assigned to get weighted values. Sums of the individual weighted values corresponding to individual players are computed. At 218, computed sums corresponding to the individual players are divided by a total weight of the set of parameters to get weighted average for individual players. At 220, the set of players are sorted in descending order of weighted average and rendered in a user interface.

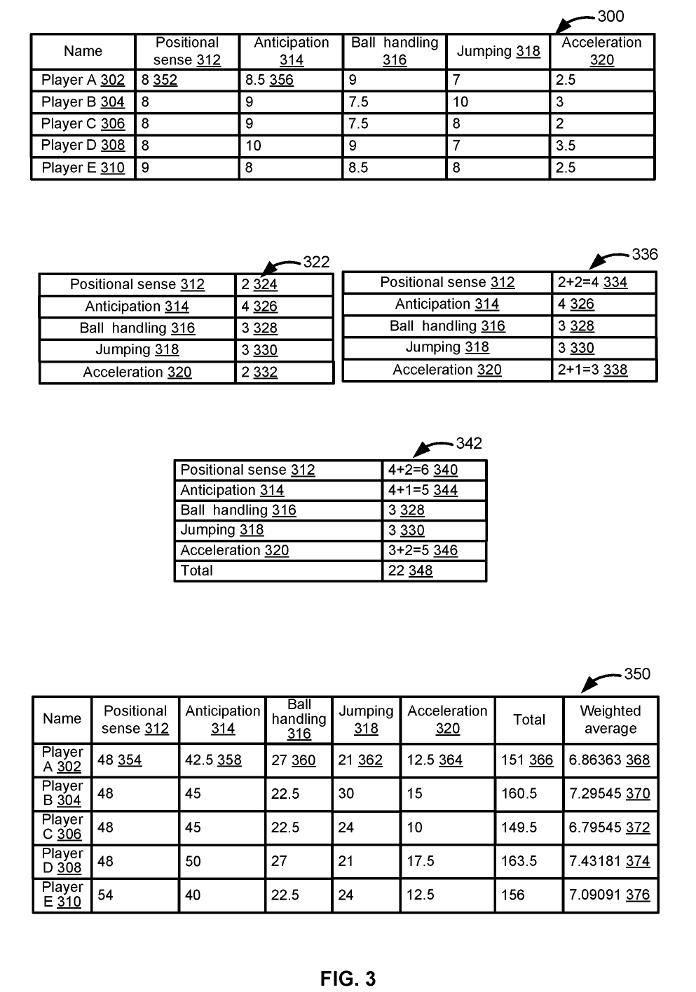

FIG. 3 illustrates dynamic analysis of scouting for goalkeepers using exemplary data, according to one embodiment. The example below is explained with reference to a scenario where scouting for goalkeepers is performed when no player is available in sweeper position and a tactic offside trap is used. Consider a sample data set 300 with five players such as player A 302, player B 304, player C 306, player D 308 and player E 310 along with parameters such as positional sense 312, anticipation 314, ball handling 316, jumping 318 and acceleration 320. Weights are assigned to the individual parameters as shown in table 322. For example, weight ‘2’ 324 is assigned to the parameter positional sense 312, weight ‘4’ 326 is assigned to the parameter anticipation 314, weight ‘3’ 328 is assigned to the parameter ball handling 316. Similarly, weight ‘3’ 330 is assigned to parameter jumping 318, and weight of ‘2’ 332 is assigned to the parameter acceleration 320.

In a first scenario it is determined whether a player in sweeper position is present or absent. Upon determining that the player in sweeper position is absent, the weight ‘2’ 324 of the parameter positional sense 312 is incremented by ‘2’ to a sum of weight ‘4’ 334 as shown in table 336. Similarly, the weight ‘2’ 332 of the parameter acceleration 320 is incremented by ‘1’ to a sum of weight ‘3’ 338. Further, it is also determined whether the parameter tactic used is offside trap. Determination of whether the player in sweeper position is present or absent, and determination of whether the parameter tactic used is offside trap are referred to as first set of criteria. Set of criteria is merely indicative, the determined conditions can be modified based on a corresponding position. Upon determining that the parameter tactic used is offside trap, the weight ‘4’ 334 of the parameter positional sense 312 in the table 336 is further incremented by ‘2’ to a sum of weight ‘6’ 340 as shown in table 342. The weight ‘4’ 326 of the parameter anticipation 314 in the table 336 is incremented by weight ‘1’ to a sum of weight ‘5’ 344 as shown in table 342, and the weight ‘3’ 338 of the parameter ‘acceleration’ 320 is incremented by ‘2’ to a sum of weight ‘5’ 346. Total weight or aggregated score of the parameters is computed as ‘6’ 340+‘5’ 344+‘3’ 328+‘3’ 330+‘5’ 346=‘22’ 348.

Values corresponding to the individual parameters in table 300 are multiplied with the corresponding weight of the individual parameters in table 342 to compute weighted sums of the individual parameters for the individual players as shown in table 350. Weight ‘6’ 340 of the parameter positional sense 312 is multiplied with a value ‘8’ 352 of the parameter positional sense as weighted value ‘48’ 354 for player A 302. Weight ‘5’ 344 of the parameter anticipation 314 is multiplied with the value ‘8.5’ 356 of the parameter anticipation to compute a weighted value ‘42.5’ 358 of the parameter anticipation 314 for player A 302. Similarly, weighted values are computed for the parameter ball handling 316 as ‘27’ 360, the parameter jumping 318 as ‘21’ 362, and the parameter acceleration 320 as ‘12.5’ 364. Similarly, weighted values are computed for player B 304, player C 306, player D 308 and player E 310. Weighted value ‘48’ 354 for the parameter positional sense 312, ‘42.5’ 358 for the parameter anticipation 314, ‘27’ 360 for the parameter ball handling 316, ‘21’ 362 for the parameter jumping 318, and ‘12.5’ 364 for the parameter acceleration are added to a total of ‘151’ 366. Total ‘151’ 366 is divided by the total weight of the parameters ‘22’ 348 as weighted average 151/22=‘6.86363’ 368. Similarly, weighted average is calculated for player B as ‘7.29545’ 370, player C as ‘6.79545’ 372, player D as ‘7.43181’ 374 and player E as ‘7.09091’ 376. Weights assigned to the parameters while scouting for goalkeeper may be saved as a preference for future use.

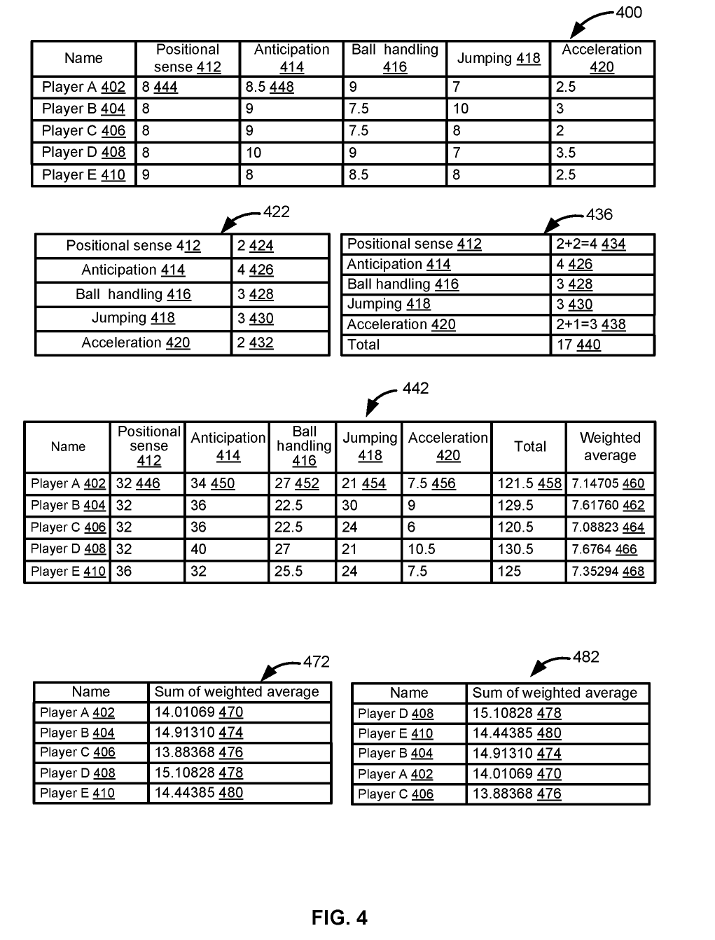

FIG. 4 illustrates dynamic analysis of scouting for goalkeepers using exemplary data, according to one embodiment. A user-defined algorithm may be executed for various scenarios such a) when a player in sweeper position is present and a parameter tactic used is offside trap, b) when a player in sweeper position is present and a parameter tactic used is man-marking, c) when no player is available in sweeper position and the tactic man-marking is used and d) when no player is available in sweeper position and the tactic offside trap is used. The example below is explained with reference to a scenario where scouting for goalkeepers is performed when no player is available in sweeper position and a tactic man-marking is used. A sample data set 400 with five players such as player A 402, player B 404, player C 406, player D 408 and player E 410 along with parameters such as positional sense 412, anticipation 414, ball handling 416, jumping 418 and acceleration 420 is considered. Weights are assigned to the individual parameters as shown in table 422. For example, weight ‘2’ 424 is assigned to the parameter positional sense 412, weight ‘4’ 426 is assigned to the parameter anticipation 414, weight ‘3’ 428 is assigned to the parameter ball handling 416. Similarly, weight ‘3’ 430 is assigned to the parameter jumping 418 and weight of ‘2’ 432 is assigned to the parameter acceleration 420. Consider a scenario where it is determined whether a player in sweeper position is present or absent. Upon determining that the player in sweeper position is absent, the weight ‘2’ 424 of the parameter positional sense 412 is incremented by ‘2’ to a sum of weight ‘4’ 434 as shown in table 436. Similarly, the weight ‘2’ of the parameter ‘acceleration’ 420 is incremented by ‘1’ to a sum of weight ‘3’ 438 as shown in table 436. Further, it is also determined whether a parameter tactic used is man-marking. Upon determining that the parameter tactic used is man-marking, total weight or aggregated score of the parameters is computed as ‘4’ 434+‘4’ 426+‘3’ 428+‘3’ 430+‘3’ 438=‘17’ 440.

Values corresponding to the individual parameters in table 400 are multiplied with the corresponding weight of the individual parameters in table 436 to compute a weighted sum of the individual parameters for the individual players as shown in table 442. Weight ‘4’ 434 of the parameter positional sense 412 is multiplied with a value ‘8’ 444 of the parameter positional sense 412 as weighted value ‘32’ 446 for player A 402. Weight ‘4’ 426 of the parameter anticipation 414 is multiplied with the value ‘8.5’ 448 of the parameter anticipation 414 to compute a weighted value ‘34’ 450 of the parameter anticipation 414 for player A 402. Similarly, weighted values are computed for the parameter ball handling 416 as ‘27’ 452, the parameter jumping 418 as ‘21’ 454, and the parameter acceleration 420 as ‘7.5’ 456. Similarly, weighted values are computed for player B 404, player C 406, player D 408 and player E 410. Weighted value ‘32’ 446 for the parameter positional sense 412, ‘34’ 450 for the parameter anticipation 414, ‘27’ 452 for the parameter ball handling 416, ‘21’ 454 for the parameter jumping 418, and ‘7.5’ 456 for the parameter acceleration 420 are added to a total of ‘121.5’ 458. Total ‘121.5’ 458 is divided by a total weight of the parameters ‘17’ 440 as weighted average 121.5/17=‘7.14705’ 460. Similarly, weighted average is calculated for player B 404 as ‘7.6176’ 462, player C 406 as ‘7.08823’ 464, player D 408 as ‘7.6764’ 466 and player E 410 as ‘7.35294’ 468.

Sums of the weighted average of the players computed in table 350 in FIG. 3 and in table 442 are determined. In the example considered, sum of the weighted average of players are computed for the two scenarios explained with reference to FIG. 3 and FIG. 4. However, it should be appreciated that the sum of weighted average may be computed for all the four scenarios (a)-(d) noted above. Sum of weighted average ‘6.86363’ 368 in table 350 in FIG. 3 and ‘7.14705’ 460 in table 442 in FIG. 4 is calculated as ‘14.01069’ 470 for player A 402 as shown in table 472. Similarly, weighted average is calculated as ‘14.91310’ 474 for player B 404, ‘13.88368’ 476 for player C 406, ‘15.10828’ 478 for player D 408 and ‘14.44385’ 480 for player E 410. The players are sorted in descending order of the sum of the weighted average of the players and rendered as shown in table 482. Players may be ranked or rated based on the weighted average or the sum of weighted average. Ranking or rating may be numerical or alphanumerical. Player D 408 has the highest sum of weighted average and is observed to be the best goalkeeper.

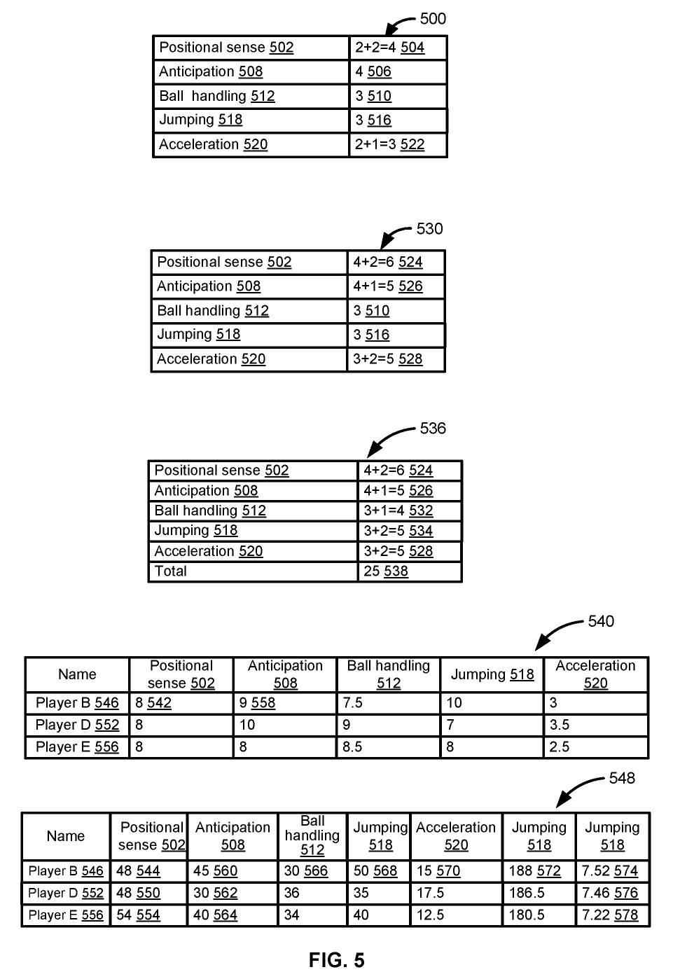

When scouting of goalkeepers is performed as shown in FIG. 4, player D 408, player E 410 and player B 404 are identified as top three goalkeepers as shown in table 482. Consider a scenario where selection of goalkeeper is performed from the previously scouted players player B 404, player D 408 and player E 410 on a day before a match. FIG. 5 illustrates dynamic analysis of selection of goalkeepers using exemplary data, according to one embodiment. It is determined that a player in sweeper position is absent. Upon determining that the player in sweeper position is absent, weight ‘2’ of a parameter positional sense 502 is incremented by ‘2’ to a sum of ‘4’ 504 as shown in table 500. Weight ‘4’ 506 is assigned to a parameter ‘anticipation’ 508, weight ‘3’ 510 is assigned to a parameter ball handling 512 and weight ‘3’ 516 is assigned to the parameter jumping 518. Weight ‘2’ of a parameter acceleration 520 is incremented by ‘1’ to a sum of ‘3’ 522. Further, it is also determined that a tactic used is offside trap. Upon determining that the tactic used is offside trap, the weight ‘4’ of the parameter positional sense 502 is incremented by ‘2’ to a sum ‘6’ 524, weight ‘4’ of the parameter anticipation 508 is incremented by ‘1’ to a sum ‘5’ 526, weight of the parameter ball handling 512 is determined to be ‘3’ 510, weight of the parameter jumping 518 is determined to be ‘3’ 516 and weight ‘3’ of the parameter acceleration 520 is incremented by ‘2’ to a sum ‘5’ 528 as shown in table 530. Further it is assumed that an average height of opponent players is greater than that of players in current team. The weight of the parameter positional sense 502 is determined to be ‘6’ 524, weight of the parameter anticipation 508 is determined to be ‘5’ 526, weight ‘3’ of the parameter ball handling 512 is incremented by ‘1’ to a sum ‘4’ 532, weight ‘3’ of the parameter jumping 518 is incremented by ‘2’ to a sum ‘5’ 534, weight of the parameter acceleration is determined to be ‘5’ 528 as shown in table 536. Accordingly, total weight or aggregated sum of the parameters is computed as ‘6’ 524+‘5’ 526+‘4’ 532+‘5’ 534+‘5’ 528=‘25’ 538.

Values corresponding to the individual parameters in table 540 are multiplied with the corresponding weight of the individual parameters in table 536 to compute weighted sum of individual parameters for the individual players. Weight ‘6’ 524 of the parameter positional sense 502 is multiplied with a value ‘8’ 542 of the parameter positional sense 502 to a weighted sum ‘48’ 544 for player B 546 as shown in table 548. Similarly, weighted values for the parameter positional sense 502 is computed as ‘48’ 550 for player D 552 and ‘54’ 554 for player E 556. Weight ‘5’ 526 of the parameter anticipation 508 is multiplied with the value ‘9’ 558 of parameter anticipation 508 to compute weighted measure of parameter anticipation′45′ 560 for player B 546. Similarly, weighted measure of parameter anticipation 508 is computed as ‘50’ 568 for player D 552 and ‘40’ 564 for player E 556. Weighted measure ‘48’ 544 for the parameter positional sense 502, ‘45’ 560 for the parameter anticipation 508, ‘30’ 566 for the parameter ball handling 512, ‘50’ 568 for the parameter jumping 518, and ‘15’ 570 for the parameter acceleration 520 are added to a total of ‘188’ 572. Total ‘188’ 572 is divided by a total weight of the parameters ‘25’ 538 as weighted average 188/25=‘7.52’ 574. Similarly, weighted average for player D 552 is computed as ‘7.46’ 576 and for player E 556 is computed as ‘7.22’ 578. Though player D 552 was observed as the player with highest weighted average, based on the computation before the day of the match player B 546 is observed to be the most suitable goalkeeper for the match.

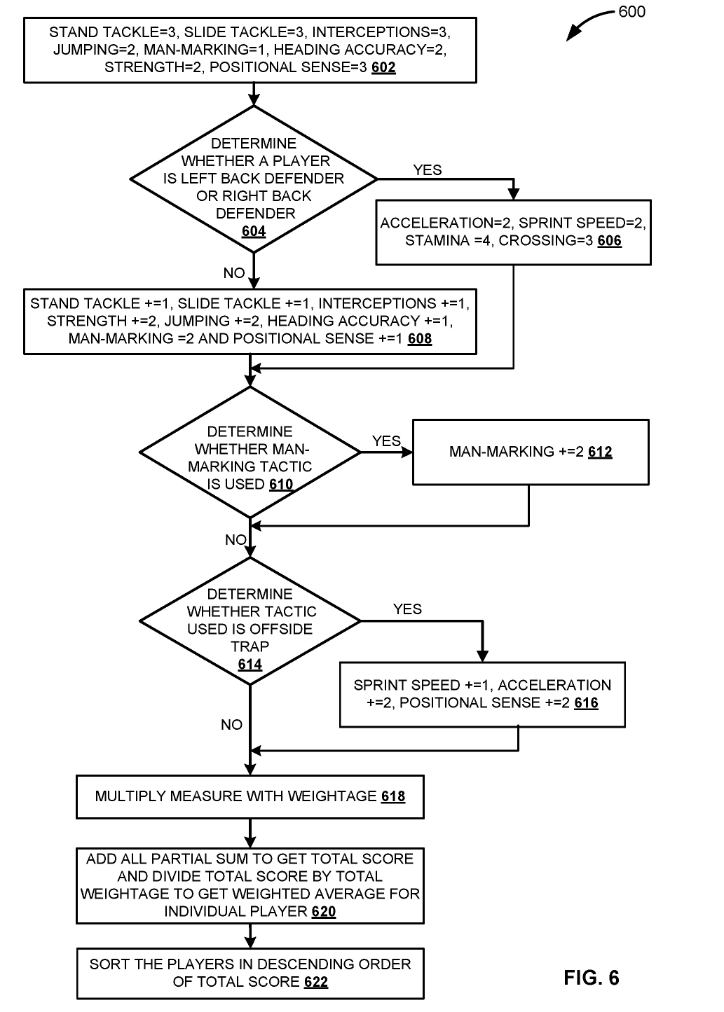

FIG. 6 is a flow diagram illustrating analysis 600 of scouting for defenders, according to one embodiment. Consider a set of players and a set of parameters such as stand tackle, slide tackle, interceptions, jumping, strength, man-marking, etc., associated with a position defender. At 602, weights are assigned to a set of parameters associated with the position defender. For example, weight ‘3’ is assigned to the parameter stand tackle, weight ‘3’ is assigned to the parameter slide tackle, weight ‘3’ is assigned to parameter interceptions. Similarly, weight of ‘2’ is assigned to the parameter jumping, weight ‘1’ is assigned to parameter man-marking, weight ‘2’ is assigned to parameter strength, and weight of ‘3’ is assigned to the parameter positional sense. At 604, it is determined whether a player is a left back defender or a right back defender. Upon determining that the player is the left back defender or the right back defender, at 606, weight ‘2’ is assigned to the parameter acceleration, weight ‘2’ is assigned to the parameter sprint speed, weight ‘4’ is assigned to the parameter stamina, and weight ‘3’ is assigned to the parameter crossing. At 608, weight of the parameter stand tackle is incremented by ‘1’, weight of the parameter slide tackle is incremented by ‘1’, weight of the parameter interceptions is incremented by ‘1’, weight of the parameter strength is incremented by ‘2’, weight of the parameter jumping is incremented by ‘2’ and weight of the parameter positional sense is incremented by ‘1’. At 610, it is determined whether a parameter tactic used by the player is man-marking. Upon determining that the tactic used is man-marking, at 612, weight of the parameter man-marking is incremented by ‘2’. At 614, it is determined whether a tactic used by the player is offside trap. Upon determining that the tactic used by the player is offside trap, at 616, the parameter sprint speed is incremented by ‘1’, the parameter acceleration is incremented by ‘2’ and the parameter positional sense is incremented by ‘2’. At 618, values corresponding to the parameters are multiplied by the weights assigned to get weighted measures. At 620, sums of the individual weighted measures corresponding to individual players are computed to get a total score. The total score is divided by total weightage to get weighted average for individual players. At 622, the players are sorted in descending order of the weighted average. The top players in the sorted list are identified as the best defenders for the criteria determined in 604, 610 and 614. Determination of whether a player is left back defender or right back defender, determination of whether the tactic used is man-marking, determination of whether the tactic used is offside trap, determination of whether a player in sweeper position is present or absent are referred to as a second set of criteria. It should be appreciated that the analysis 600 may be performed for any combination of second set of criteria noted above.

In one embodiment, to identify a best center defending midfielders from a set of players, a set of parameters such as vision, long pass, short pass, interceptions, stand tackle, positioning, acceleration, sprint speed, stamina, etc., are considered. To identify a best left midfielder or a right midfielder a set of parameters such as agility, acceleration, sprint speed, stamina, ball control, dribbling, short pass, positioning, etc., are considered. To identify a best center attacking midfielder a set of parameters such as vision, ball control, dribbling, shot accuracy, long pass, short pass, shot power, curve, agility, acceleration, sprint speed, stamina, etc., are considered. In one embodiment, analysis of scouting for strikers, according to one embodiment. To identify a best center forward striker from a set of players, a set of parameters such as finishing, heading accuracy, positional sense, volley, agility, acceleration, sprint speed, dribbling, ball control, curve, etc., are considered. To identify a best striker, a set of parameters such as finishing, heading accuracy, curve, strength, shot power, jumping, agility, etc., are considered. Based on the parameters considered for midfielders and strikers, corresponding user-defined algorithm is executed. Current availability status of the players such as available, injured: expected to return in one month, away: expected to return in one week, etc., are stored in the analysis application. The user-defined algorithm considers the current availability status of the players and identifies best strikers, best goalkeepers, etc., accordingly.

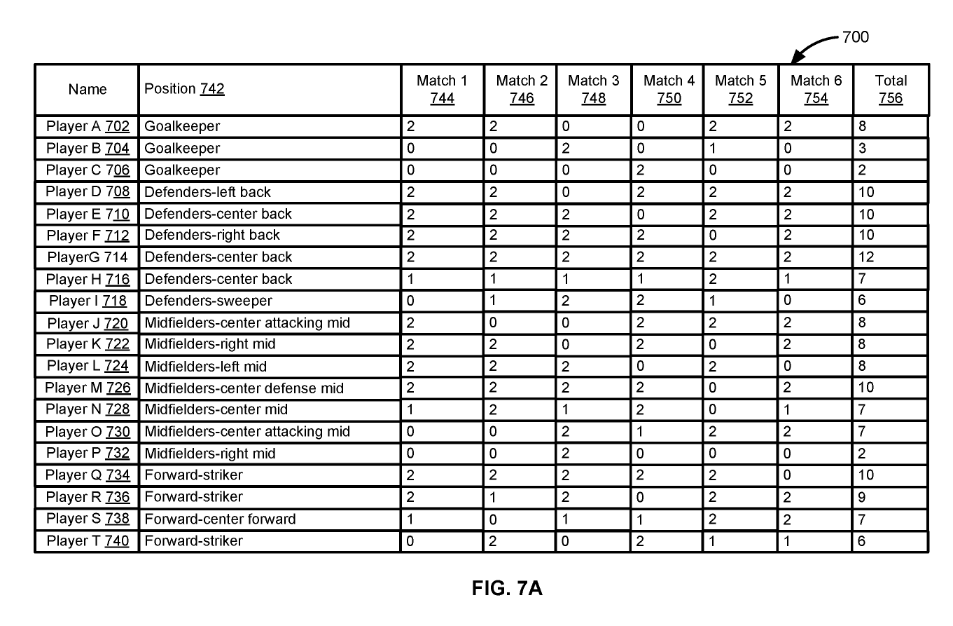

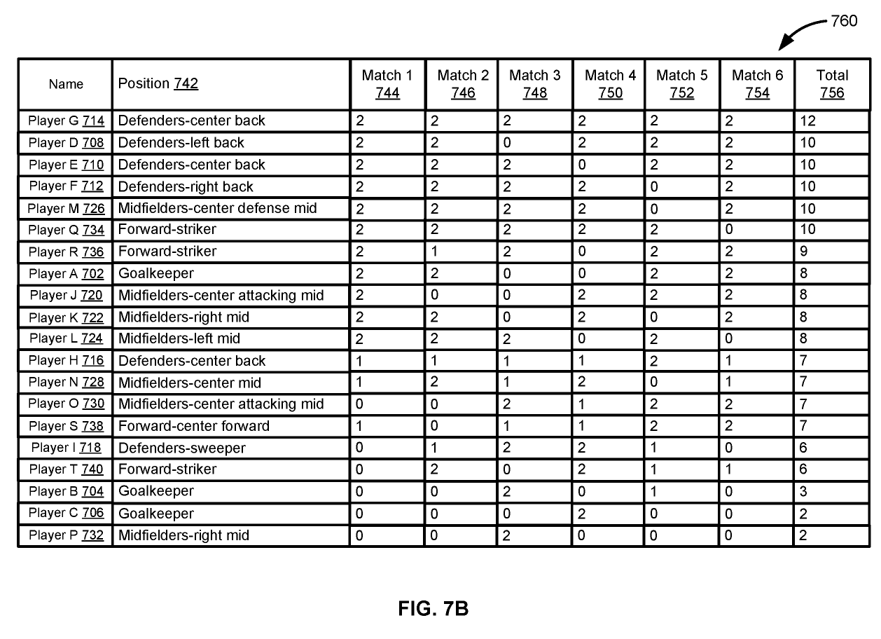

FIG. 7A and FIG. 7B in combination illustrates dynamic analysis of players in an opponent team using exemplary data, according to one embodiment. Consider a sample data set 700 in FIG. 7A with twenty players in the opponent team including players such as player A 702, player B 704, player C 706, player D 708, player E 710, player F 712, player G 714, player H 716, player I 718, player J 720, player K 722, player L 724, player M 726, player N 728, player O 730, player P 732, player Q 734, player R 736, player S 738 and player T 740. Individual players in the data set 700 are indicated with corresponding positions of the players in a field position 742. Data corresponding to players in six matches such as ‘match 1’ 744, ‘match 2’ 746, ‘match 3’ 748, ‘match 4’ 750, ‘match 5’ 752 and ‘match 6’ 754 are captured in the dataset 700. When a player starts playing in a particular match, the player is given ‘2’ points, and if the player is a substitute player in the particular match the player is given ‘1’ point, and if the player does not play in the particular match the player is given ‘0’ point. The data set 700 is constructed in this manner for six matches for twenty players. The sums of the points for individual players are calculated. For example, for player A 702, ‘2’ points in ‘match 1’ 744, ‘2’ points in ‘match 2’ 746, ‘0’ points in ‘match 3’ 748, ‘0’ point in ‘match 4’ 750, ‘2’ point in ‘match 5’ 752 and ‘2’ point in ‘match 6’ 754 are added to a total 756 of ‘8’ points 758. Similarly, sum of the points are computed for the players player B 704 to ‘player T’ 740.

Sums of the points computed for player A 702 to player T 740 are sorted in descending order as shown in table 760 in FIG. 7B. In table 760, it is inferred that that first eleven players such as player G 714, player D 708, player E 710, player F 712, player M 726, player Q 734, player R 736, player A 702, player J 720, player K 722 and player L 724 are the likely players in the opponent team to start a match. The information of the first eleven players and their positions may be displayed in the feature ‘know your opponents’ in FIG. 1 The next three players such as player H 716, player N 728 and player O 730 are the likely substitutes. Further it is also observed that from the first eleven players there is one goalkeeper, four defenders, 4 midfielders, and 2 strikers. In defenders there are two center backs, one left back, and one right back. In mid there are one center defense mid, one right mid, one left, and one center attacking mid, and in forward, there are two strikers. Accordingly, it is likely that a 4-4-2 diamond formation may be played by the opponent team. In ‘know your opponents’ feature there may also be a feature to ‘analyze’ opponent player's statistics. When the ‘analyze’ feature is selected, matches recently lost by the opponent team may be selected, and formations used in those matches are analyzed and rendered in the user interface. The matches played by opponent team along with formation used may be stored corresponding to opponent team manager in an analysis application. At a later point, matches won by the opponent team along with the formation used can be searched in the analysis application.

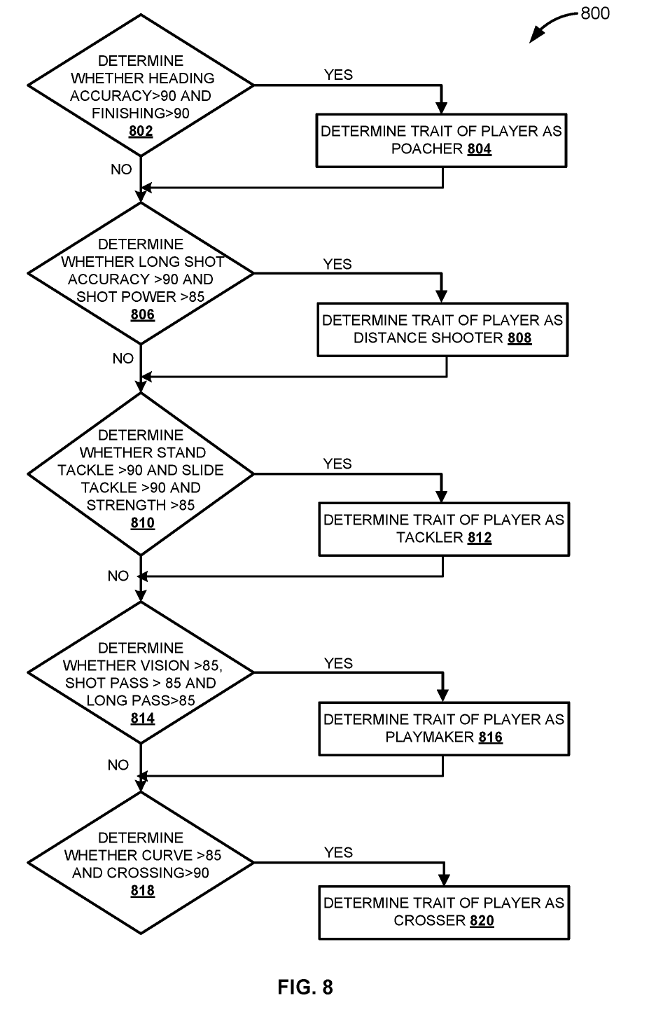

FIG. 8 illustrates dynamic assignment of traits to players in a team using exemplary data, according to one embodiment. Individual players can be assigned a parameter trait based on the player's physical capability. Various traits that can be assigned to a player are poacher, distance shooter, tactician, playmaker, crosser, etc. Poacher is a player good inside opponents' box, distance shooter is a player capable of swinging a ball from a distance when an open space is found, tactician is a player acting as a leader on pitch, brilliant at reading the game and cutting out plays such as through balls, counterattacks, etc. Playmaker is a player specializing in delivering a final pass that breaks through defense, crosser is a player good at swinging accurate crosses and finding his teammates with his crossing, etc. Players with various parameters and values associated with the parameters are provided as input to algorithm 800 to identify traits of players. Algorithm 800 to identify traits of players shows conditions to identify some of the traits. This list of conditions and player traits are merely exemplary and not limited to the list provided below. At 802, it is determined whether a parameter heading accuracy is greater than ‘90’ and a parameter ‘finishing’ is greater than ‘90’. Upon determining that the parameter heading accuracy is greater than ‘90’ and the parameter finishing is greater than ‘90’, at 804, trait of a player is determined as poacher.

At 806, it is determined whether parameter long shot accuracy is greater than ‘90’ and a parameter ‘shot power’ is greater than ‘85’. Upon determining that the parameter long shot accuracy is greater than ‘90’ and the parameter shot power is greater than ‘85’, at 808, trait of a player is determined as distance shooter. At 810, it is determined whether a parameter stand tackle is greater than ‘90’, a parameter slide tackle is greater than ‘90’, and a parameter strength is greater than ‘85’. Upon determining that the parameter stand tackle is greater than ‘90’, the parameter slide tackle is greater than ‘90’, and the parameter strength is greater than ‘85’, at 812, trait of a player is determined as tackler. At 814, it is determined whether a parameter vision is greater than ‘85’, a parameter short pass is greater than ‘85’, and a parameter long pass is greater than ‘85’. Upon determining that the parameter vision is greater than ‘85’, the parameter short pass is greater than ‘85’, and the parameter long pass is greater than ‘85’, at 816, trait of a player is determined as playmaker. At 818, it is determined whether a parameter curve is greater than ‘85’, and a parameter crossing is greater than ‘90’. Upon determining that the parameter curve is greater than ‘85’, and the parameter crossing is greater than ‘90’, at 820, trait of a player is determined as crosser.

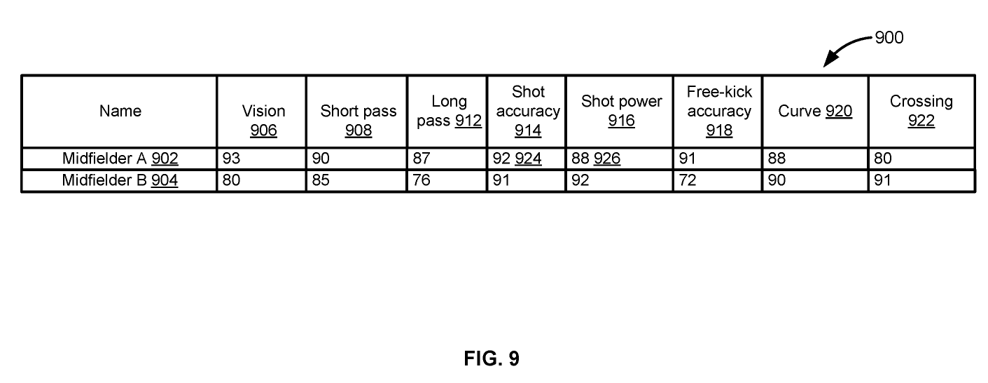

FIG. 9 illustrates dynamic assignment of traits to players in a team using exemplary data, according to one embodiment. Consider dataset 900 with two players midfielder A 902 and midfielder B 904, along with values of parameters such vision 906, short pass 908, long pass 912, shot accuracy 914, shot power 916, free-kick accuracy 918, curve 920 and crossing 922. When algorithm 800 in FIG. 8 is executed for the dataset 900, midfielder A 902 with ‘92’ 924 for the parameter shot accuracy 914 and ‘88’ 926 for the parameter shot power 916 satisfies criteria in 806. Accordingly, midfielder A 902 is determined to have traits of a distance shooter based on the determination in 808. Similarly, based on the algorithm, midfielder A′ 902 is also determined to have traits of a playmaker, set-piece specialist and complete midfielder. Based on the data in the dataset 900, midfielder B 904 is determined to have traits of a distance shooter and crosser. The determined traits of the players may be displayed in a ‘player bio card’ 110 of FIG. 1. Determination of traits of the player in the algorithm 800 may be referred to as a third set of criteria. The traits of the players are displayed along with information about the players such as name, age, nationality, goals scored, etc.

In one embodiment, players are analyzed based on the matches played for a specified period of time. For example, a set of players along with details corresponding to various matches played by the set of players for a specified period such as February-March 2015 is selected for analysis. The set of players along with details corresponding to various matches played for April-May 2015 is selected for analysis. The data or weighted averages corresponding to both the periods are compared and the result of the analysis is displayed as performance analysis of the set of players. The result of the analysis may be rendered as a graphical representation in a user interface. Similarly, two different sets of players are analyzed for a specified period and the result of the analysis is displayed as a graphical representation in the user interface. A team manager may schedule trainings and notification of the trainings is sent to specific players using the analysis application. For example, if a goalkeeper training is scheduled for a particular day, a meeting request is sent out to all the Goalkeepers.

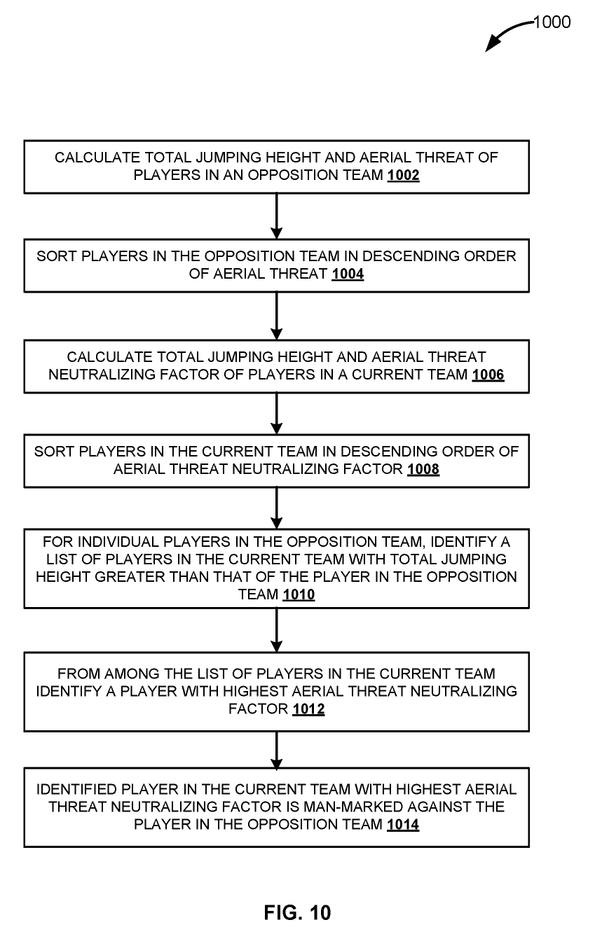

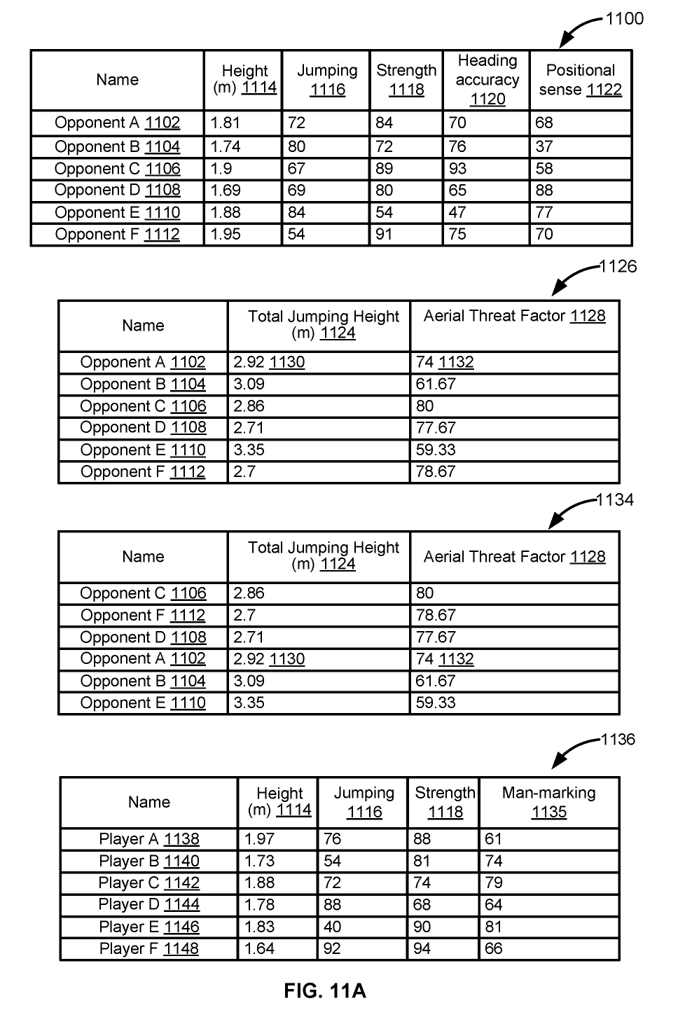

FIG. 10 illustrates dynamic determination of man-to-man marking of players in set pieces, according to one embodiment. Man-to-man marking, or man marking, is a defensive strategy where defenders are assigned a specific opponent player to mark rather than covering an area of the pitch. Algorithm 1000 is used in dynamic determination of man-to-man marking of players in set-pieces. At 1002, total jumping height and aerial threat of players in an opponent team is calculated. At 1004, players in the opponent team are sorted in descending order of aerial threat. At 1006, total jumping height and serial threat neutralizing factor of players in a current team are calculated. At 1008, the players in the current team are sorted in descending order of aerial threat neutralizing factor. At 1010, for individual players in the opponent team, a list of players in the current team with total jumping height greater than that of the player in the opponent team are identified. At 1012, from among the list of players in the current team, a player with the highest aerial threat neutralizing factor is identified. At 1014, players in the current team with the highest aerial threat neutralizing factor is man-marked against the player in the opponent team.

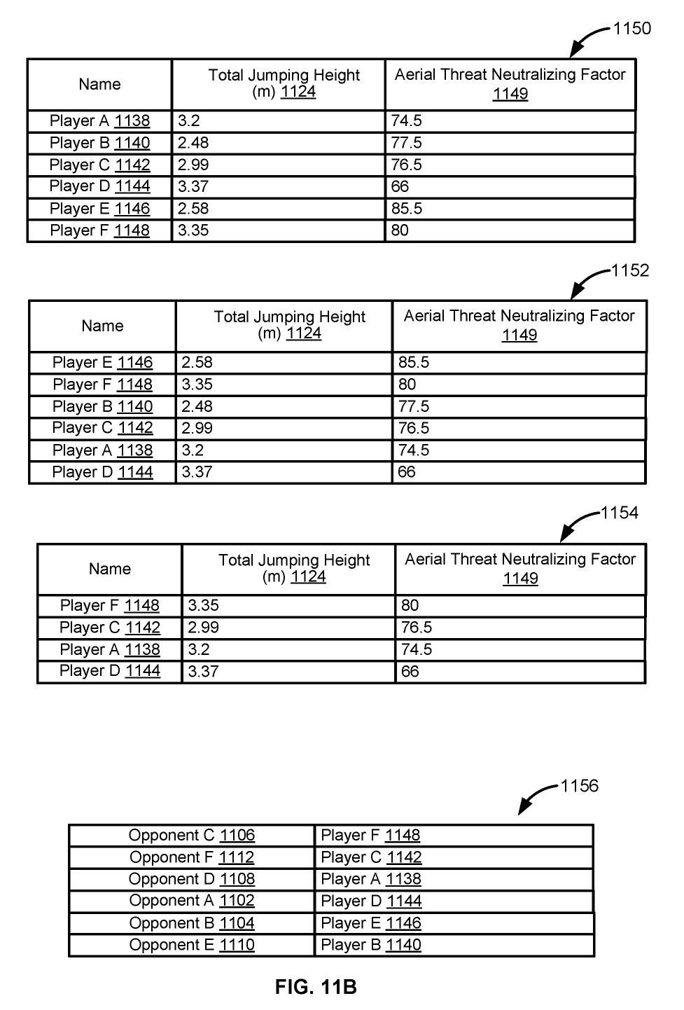

FIG. 11A and FIG. 11B in combination illustrates dynamic determination of man-to-man marking of players in set-pieces using exemplary data, according to one embodiment. Consider a first dataset 1100 with data corresponding to players in opponent team such as opponent A 1102, opponent B 1104, opponent C 1106, opponent D 1108, opponent E 1110, and opponent F 1112 along with various parameters. Various parameters available in the dataset 1100 are height(m) 1114, jumping 1116, strength 1118, heading accuracy 1120 and positional sense 1122. Total jumping height 1124 is calculated for the players in the opponent team using the formula:

Total jumping height=Height+0.75+(Jumping−60)*0.03

Consider player opponent A 1102 with ‘1.81’ height and ‘72’ jumping. Total jumping height 1124 is calculated in meters by substituting the values in the equation as 1.81+0.75+(72-60)*0.03=‘2.92’ 1130 as shown in table 1126. Similarly, total jumping height is calculated for the other opponent players as shown in table 1126. The aerial threat factor 1128 is calculated for players in the opponent team using the formula:

Aerial Threat Factor=(Strength+Heading Accuracy+Positional sense)/3

Data values in the first dataset 1100 are substituted in the formula above, and the aerial threat factor 1128 is calculated. Consider the player ‘opponent A’ 1102 with ‘84’ strength, ‘70’ heading accuracy and ‘68’ positional sense, aerial threat factor is calculated by substituting the values in the equation as (84+70+68)/3=‘74’ 1132 as shown in table 1126. Sort the players in the opponent team in descending order of aerial threat factor as shown in table 1134. Consider a second data set 1136 including players of current team such as player A 1138, player B 1140, player C 1142, player D 1144, player E 1146 and player F 1148 along with various parameters such as height(m) 1114, jumping 1116, strength 1118 and man-marking 1135. Total jumping height is calculated using a formula:

Total jumping height=Height+0.75+(Jumping−60)*0.03

Aerial threat neutralizing factor 1149 is calculated for the players in the current team based on the parameters considered. Aerial threat neutralizing factor 1149 is calculated using the formula:

Aerial Threat Neutralizing Factor=(Strength+Man marking)/2

Data values in the second dataset 1136 are substituted in the formula, and aerial threat neutralizing factor 1149 is calculated as shown in table 1150 in FIG. 11B. The players in the current team are sorted in descending order of aerial threat neutralizing factor as shown in table 1152. For man-to-man marking of players, compare the opponent players in table 1134 with players in the current team in table 1152. For each opponent player identify corresponding player in the current team taller than the opponent player. Among the identified players in the current team, a single player with highest aerial threat neutralizing factor is identified. For player opponent C 1106 with a total jumping height of ‘2.86’, a set of three current players taller than the player opponent C 1106 are identified as in table 1154. The set of four current players are identified as player F 1148, player C 1142, player A 1138 and player D 1144. From among the four players, player F 1148 has the highest aerial threat neutralizing factor ‘80’, and accordingly player F 1148 is selected to man-mark player opponent C 1106. Similarly, current players are selected to man-mark individual opponent players as shown in table 1156. In a scenario where there are no current players taller than the opponent player the tallest current player is selected to man-mark the considered player in the opponent team.

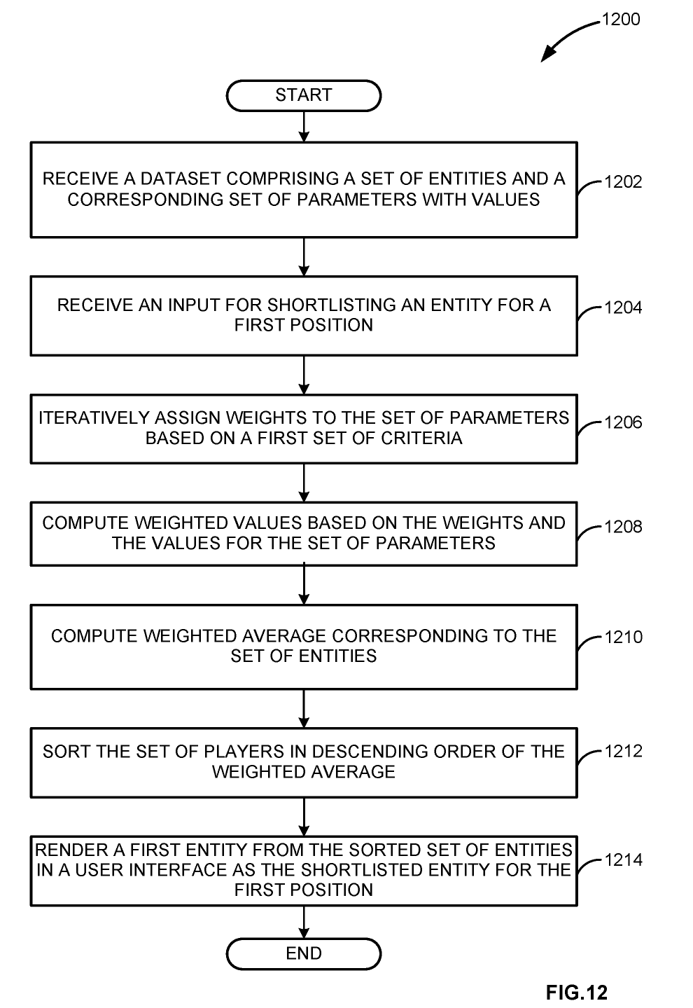

FIG. 12 is a flow diagram illustrating process 1200 of dynamic analysis of entities, according to one embodiment. At 1202, a dataset including a set of entities and a corresponding set of parameters with values are received. At 1204, an input for shortlisting an entity for a first position is received. At 1206, weights are assigned to the set of parameters based on a first set of criteria iteratively. At 1208, weighted values based on the weights and the values for the set of parameters are computed. At 1210, weighted average corresponding to the set of entities are computed. At 1212, the set of entities in descending order of the weighted average are sorted. At 1214, a first entity from the sorted set of entities is rendered in a user interface as the shortlisted entity for the first position.

In one embodiment, an input is received for shortlisting an entity for a second position. Weights are assigned iteratively to the set of parameters based on a second set of criteria. Weighted values are computed based on the weights and the values for the set of parameters. Weighted average corresponding to the set of entities are computed. The set of entities are sorted in descending order of the weighted average. The first entity from the sorted set of entities previously selected for a different position are displayed as the shortlisted entity for the second position. Same entity can be selected for different positions. A person of ordinary skill in the relevant art will recognize, however, that the embodiments can be practiced in various domains such as human resource information system (HRIS), enterprise transport system, medical applications, enterprise resource planning (ERP) application, etc.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

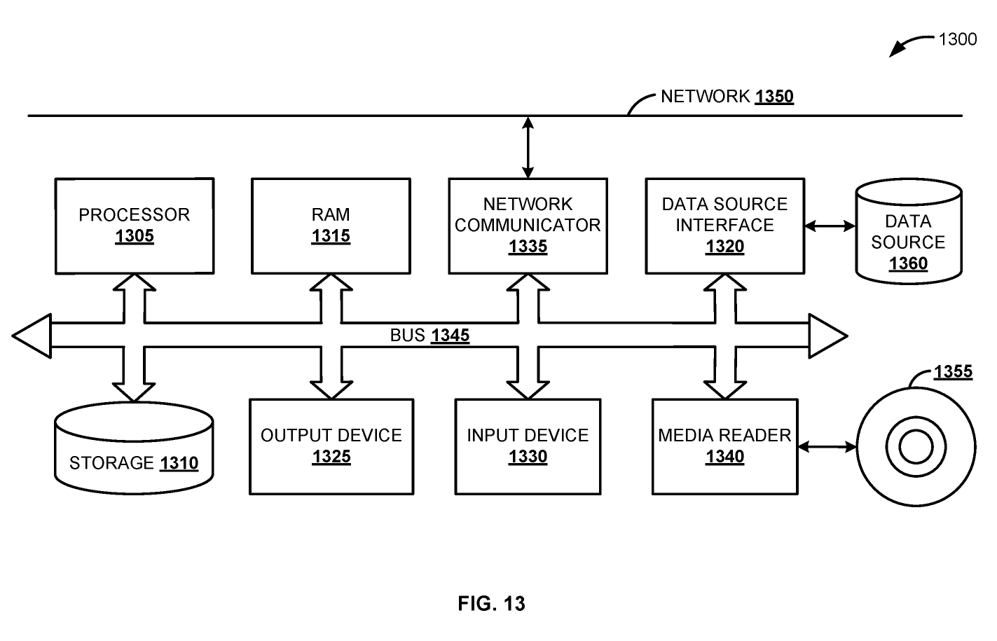

FIG. 13 is a block diagram of an exemplary computer system 1300. The computer system 1300 includes a processor 1305 that executes software instructions or code stored on a computer readable storage medium 1355 to perform the above-illustrated methods. The computer system 1300 includes a media reader 1340 to read the instructions from the computer readable storage medium 1355 and store the instructions in storage 1310 or in random access memory (RAM) 1315. The storage 1310 provides a large space for keeping static data where at least some instructions could be stored for later execution. The stored instructions may be further compiled to generate other representations of the instructions and dynamically stored in the RAM 1315. The processor 1305 reads instructions from the RAM 1315 and performs actions as instructed. According to one embodiment, the computer system 1300 further includes an output device 1325 (e.g., a display) to provide at least some of the results of the execution as output including, but not limited to, visual information to users and an input device 1330 to provide a user or another device with means for entering data and/or otherwise interact with the computer system 1300. Each of these output devices 1325 and input devices 1330 could be joined by one or more additional peripherals to further expand the capabilities of the computer system 1300. A network communicator 1335 may be provided to connect the computer system 1300 to a network 1350 and in turn to other devices connected to the network 1350 including other clients, servers, data stores, and interfaces, for instance. The modules of the computer system 1300 are interconnected via a bus 1345. Computer system 1300 includes a data source interface 1320 to access data source 1360. The data source 1360 can be accessed via one or more abstraction layers implemented in hardware or software. For example, the data source 1360 may be accessed by network 1350. In some embodiments the data source 1360 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a dataset comprising a set of entities and a corresponding set of parameters with values;
receive an input for shortlisting an entity for a first position;
iteratively assign weights to the set of parameters based on a first set of criteria;
compute weighted values based on the weights and the values for the set of parameters;
compute weighted average corresponding to the set of entities;
sort the set of entities in descending order of the weighted average; and
render a first entity from the sorted set of entities in a user interface as the shortlisted entity for the first position.

2. The computer-readable medium of claim 1, further comprising instructions which when executed by the computer further causes the computer to:
receive an input for shortlisting an entity for a second position;
iteratively assign weights to the set of parameters based on a second set of criteria;
compute weighted values based on the weights and the values for the set of parameters;
compute weighted average corresponding to the set of entities;
sort the set of entities in descending order of the weighted average; and
render the first entity from the sorted set of entities in the user interface as the shortlisted entity for the second position.

3. The computer-readable medium of claim 1, further comprising instructions which when executed by the computer further causes the computer to:
assign points to the set of entities corresponding to matches played by the set of entities;
sort the set of entities in descending order of computed sums of the points;
based on the sorted set of entities, predict the set of entities starting a match; and
based on the sorted set of entities, identify a formation of the set of entities in a field.

4. The computer-readable medium of claim 1, further comprising instructions which when executed by the computer further causes the computer to:
for the set of entities, compare the set of parameters with a weighted average for a first specified period and the set of parameters with a weighted average for a second specified period; and
render a result of comparison in the user interface.

5. The computer-readable medium of claim 1, further comprising instructions which when executed by the computer further causes the computer to:
upon determining that a third set of criteria is satisfied, assign a trait corresponding to an entity from among the set of entities; and
render the trait corresponding to the entity along with details associated with the entity in the user interface.

6. The computer-readable medium of claim 1, further comprising instructions which when executed by the computer further causes the computer to:
compute a total jumping height and an aerial threat neutralizing factor corresponding to the set of players;
sort the set of players based on descending order of the aerial threat neutralizing factor;
compute a total jumping height and an aerial threat factor corresponding to a set of opponent players;
sort the set of opponent players based on descending order of aerial threat factor; and
identify a player from the set of players corresponding to an opponent player from the set of opponent players based on the computed aerial threat neutralizing factor and aerial threat factor.

7. The computer-readable medium of claim 1, further comprising instructions which when executed by the computer further causes the computer to:
rank the set of players based on the weighted average.

8. A computer-implemented method for dynamic analysis of entities, the method comprising:
receiving a dataset comprising a set of entities and a corresponding set of parameters with values;
receiving an input for shortlisting an entity for a first position;
iteratively assigning weights to the set of parameters based on a first set of criteria;
computing weighted values based on the weights and the values for the set of parameters;
computing weighted average corresponding to the set of entities;
sorting the set of entities in descending order of the weighted average; and
rendering a first entity from the sorted set of entities in a user interface as the shortlisted entity for the first position.

9. The method of claim 8, further comprising:
receiving an input for shortlisting an entity for a second position;
iteratively assigning weights to the set of parameters based on a second set of criteria;
computing weighted values based on the weights and the values for the set of parameters;
computing weighted average corresponding to the set of entities;
sorting the set of entities in descending order of the weighted average; and
rendering the first entity from the sorted set of entities in a user interface as the shortlisted entity for the second position.

10. The method of claim 8, further comprising:
assigning points to the set of entities corresponding to matches played by the set of entities;
sorting the set of entities in descending order of computed sums of the points;
based on the sorted set of entities, predicting the set of entities starting a match; and
based on the sorted set of entities, identifying a formation of the set of entities in a field.

11. The method of claim 8, further comprising:
for the set of entities, comparing the set of parameters with a weighted average for a first specified period and the set of parameters with a weighted average for a second specified period; and
rendering a result of comparison in the user interface.

12. The method of claim 8, further comprising:
upon determining that a third set of criteria is satisfied, assigning a trait corresponding to an entity from among the set of entities; and
rendering the trait corresponding to the entity along with details associated with the entity in the user interface.

13. The method of claim 8, further comprising:
computing a total jumping height and an aerial threat neutralizing factor corresponding to the set of players;
sorting the set of players based on descending order of the aerial threat neutralizing factor;
computing a total jumping height and an aerial threat factor corresponding to a set of opponent players;
sorting the set of opponent players based on descending order of aerial threat factor; and
identifying a player from the set of players corresponding to an opponent player from the set of opponent players based on the computed aerial threat neutralizing factor and aerial threat factor.

14. The method of claim 8, further comprising:
rank the set of players based on the weighted average.

15. A computer system for dynamic analysis of entities, comprising:
a computer memory to store program code; and
a processor to execute the program code to:
receive a dataset comprising a set of entities and a corresponding set of parameters with values;
receive an input for shortlisting of an entity for a first position;
iteratively assign weights to the set of parameters based on a first set of criteria;
compute weighted values based on the weights and the values for the set of parameters;
compute weighted average corresponding to the set of entities;
sort the set of entities in descending order of the weighted average; and
render a first entity from the sorted set of entities in a user interface as the shortlisted entity for the first position.

16. The system of claim 15, wherein the processor further executes the program code to:
receive an input for shortlisting an entity for a second position;
iteratively assign weights to the set of parameters based on a second set of criteria;
compute weighted values based on the weights and the values for the set of parameters;
compute weighted average corresponding to the set of entities;
sort the set of entities in descending order of the weighted average; and
render the first entity from the sorted set of entities in a user interface as the shortlisted entity for the second position.

17. The system of claim 15, wherein the processor further executes the program code to:
assign points to the set of entities corresponding to matches played by the set of entities;
sort the set of entities in descending order of computed sums of the points;
based on the sorted set of entities, predict the set of entities starting a match; and
based on the sorted set of entities, identify a formation of the set of entities in a field.

18. The system of claim 15, wherein the processor further executes the program code to:
upon determining that a third set of criteria is satisfied, assign a trait corresponding to an entity from among the set of entities; and
render the trait corresponding to the entity along with details associated with the entity in the user interface.

19. The system of claim 15, wherein the processor further executes the program code to:
for the set of entities, compare the set of parameters with a weighted average for a first specified period and the set of parameters with a weighted average for a second specified period; and
render a result of comparison in the user interface.

20. The system of claim 15, wherein the processor further executes the program code to:
compute a total jumping height and an aerial threat neutralizing factor corresponding to the set of players;
sort the set of players based on descending order of the aerial threat neutralizing factor;
compute a total jumping height and an aerial threat factor corresponding to a set of opponent players;
sort the set of opponent players based on descending order of aerial threat factor; and
identify a player from the set of players corresponding to an opponent player from the set of opponent players based on the computed aerial threat neutralizing factor and aerial threat factor.
